(19) United States
(12) Patent Application Publication
(10) Pub. No.: US 2008/0186589 A1
(43) Pub. Date: Aug. 7, 2008

(54) Compact Stepping Lens Actuator for Mobile Cameras

(75) Inventors: Gerardus L.M. Jansen, De Rips (NL); Rudy J.H. Van Den, Wanroij (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,014

(22) PCT Filed: Apr. 24, 2006
(86) PCT No.: PCT/IB2006/051270

§ 371 Date: Oct. 9, 2007

Related U.S. Application Data
(60) Provisional application No. 60/676,223, filed on Apr. 29, 2005.

(51) Int. Cl. G02B 7/04

(52) U.S. Cl. 359/694; 359/824

(57) ABSTRACT

An actuator (100) including: a housing (102); a driven member (104) movably disposed with respect to the housing; a magnet (114) associated with the driven member and a ferric member (112) for providing a magnetic attraction force between the driven member and the ferric member for providing a normal force (Fn) between the housing and driven member such that a friction force between the housing and driven member resulting from the normal force must be overcome to initiate a relative movement between the housing and driven member; and a magnetic drive system (118, 120) for overcoming the friction force and driving the driven member relative to the housing. The driven member can be a lens holder for holding a lens (106), in which case, the actuator can further include an image sensor (110) for acquiring image data through the lens.

The present invention relates generally to actuators, and more particularly, to compact, inexpensive lens actuators for mobile cameras.

Lens actuators for small mobile camera systems are well known in the art. For example, mobile camera systems are known which utilize voice coil systems without a sensor. In such a system, the lens is guided by a stiff suspension system where a constant current through the coil generates a constant force resulting in a position change. However, such a system suffers from relatively high power dissipation in the system and the lens is not very well controlled. Similarly, voice coil systems are utilized with a sensor. In such a system, the suspension of the lens can have a low stiffness, however, the system needs to be controlled by a PID control loop with a sensor. Although the dissipation can be relatively low in such a system, the system is very complex and expensive.

Piezo driven systems are also known in the art. Such systems are well suited for making small steps but are technologically difficult, require high voltages, and are expensive. Lastly, fluid focus systems are also known in the art. Such systems are technologically immature and yet to be proven. Furthermore, such fluid focus systems will most likely require high voltages and may be expensive.

Therefore it is an object of the present invention to provide methods and interactive systems that overcome these and other disadvantages associated with the prior art.

Accordingly, an actuator is provided. The actuator comprising: a housing; a driven member movably disposed with respect to the housing; a preloading means for providing a normal force between the housing and driven member such that a friction force between the housing and driven member resulting from the normal force must be overcome to initiate a relative movement between the housing and driven member; and a driving means for overcoming the friction force and driving the driven member relative to the housing.

The actuator can further comprise a bearing disposed between the housing and driven member, wherein the preloading means provides the normal force on the bearing.

The driven member can be a lens holder for holding a lens. In which case, the actuator can further comprise an image sensor for acquiring image data through the lens, wherein the relative movement of the lens holder provides one of a focus and zoom adjustment for the image sensor.

The preloading means can comprise a magnet associated with the driven member and a ferric member for providing a magnetic attraction force between the driven member and the ferric member, wherein the magnetic attraction force is substantially equal to the normal force. The ferric member can be a mounting plate attached to the housing, the mounting plate containing a ferric material. The driving means can comprise a magnetic drive system, in which case the magnetic drive system can comprise: a drive coil, the magnet generating a field in the drive coil; and control means for generating a drive current in the drive coil to generate a drive force on the driven member which overcomes the friction force and results in a relative movement of the driven member. The drive coil can be disposed in the housing.

Also provided is a method for driving an actuator. The method comprising: providing a normal force between a housing and a driven member such that a friction force between the housing and driven member resulting from the normal force must be overcome to initiate a relative movement between the housing and driven member; and overcoming the friction force to drive the driven member relative to the housing.

The providing can comprise providing a magnet associated with the driven member and a ferric member for providing a magnetic attraction force between the driven member and the ferric member, wherein the magnetic attraction force is substantially equal to the normal force. In which case the overcoming can comprise: generating a field in a drive coil with the magnet; and generating a drive current in the coil to generate a drive force on the driven member which overcomes the friction force and results in a relative movement of the driven member.

The driven member can be associated with a lens and the method can further comprise providing one of a focus and zoom adjustment between the lens and a camera due to the relative movement between the driven member and housing.

Still yet provided is a lens actuator for a camera system. The lens actuator comprising: a housing; a lens holder for holding a lens, the lens holder being movably disposed with respect to the housing; a camera in optical communication with the lens; a preloading means for providing a normal force between the housing and lens holder such that a friction force between the housing and lens actuator resulting from the normal force must be overcome to initiate a relative movement between the housing and lens holder; and a driving means for overcoming the friction force and driving the lens holder relative to the housing.

The lens actuator can further comprise a bearing disposed between the housing and lens holder, wherein the preloading means provides the normal force on the bearing.

The preloading means can comprise a magnet associated with the lens holder and a ferric member for providing a magnetic attraction force between the lens holder and the ferric member, wherein the magnetic attraction force is substantially equal to the normal force. The ferric member can be a mounting plate attached to the housing, the mounting plate containing a ferric material.

The driving means can comprise a magnetic drive system, in which case the magnetic drive system can comprise: a drive coil, the magnet generating a field in the drive coil; and control means for generating a drive current in the drive coil to generate a drive force on the driven member which overcomes the friction force and results in a relative movement of the lens holder. The drive coil can be disposed in the housing.

These and other features, aspects, and advantages of the apparatus and methods of the present invention will become better understood with regard to the following description, appended claims, and accompanying drawings where:

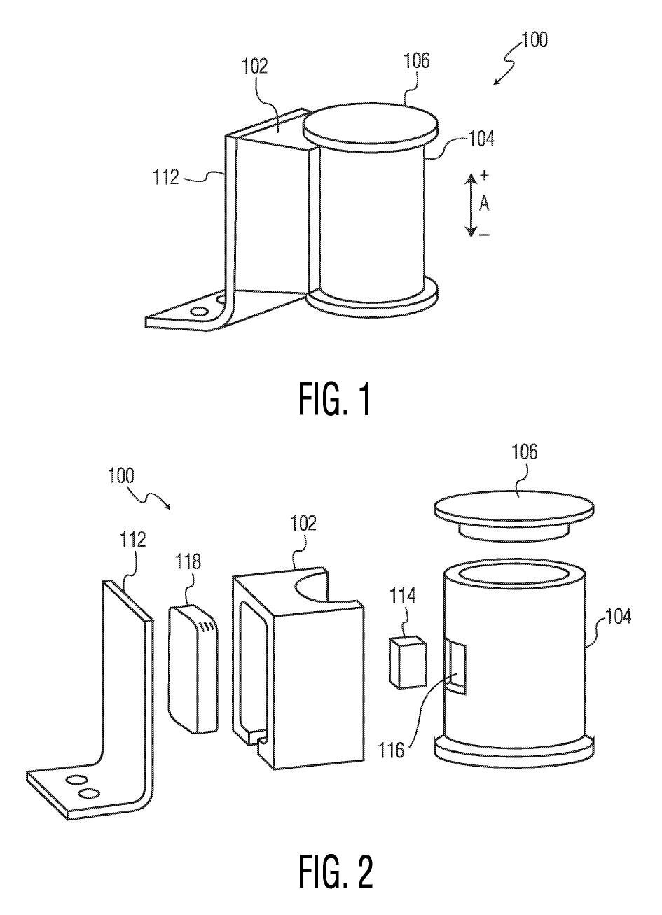

FIG. 1 illustrates a perspective view of an actuator apparatus.

FIG. 2 illustrates an exploded view of the actuator apparatus of FIG. 1.

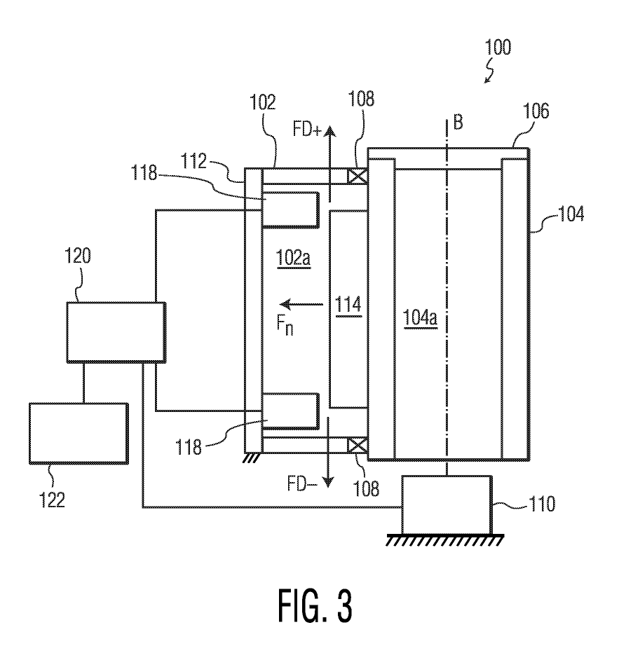

FIG. 3 illustrates a schematic view of the actuator apparatus of FIG. 1 having a control circuit and imaging means.

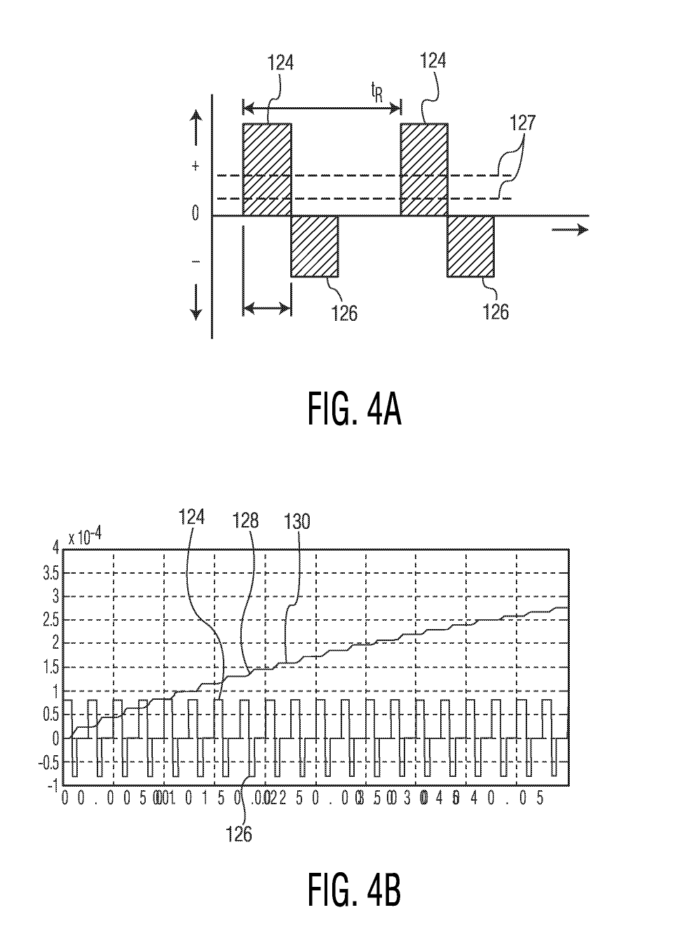

FIGS. 4A and 4B are graphs illustrating the driving of the actuator apparatus of FIG. 1.

Although this invention is applicable to numerous and various types of actuators, it has been found particularly useful in the environment of a lens actuator for mobile cameras. Therefore, without limiting the applicability of the invention to lens actuators for mobile cameras, the invention will be described in such environment. However, those skilled in the art will appreciate that the actuator of the present invention has application in other environments that require a relatively inexpensive and dependable movement of a relatively small objects, such as slide drive mechanisms in CD and DVD systems.

Referring now to FIGS. 1-3, there is illustrated a lens actuator, the lens actuator being generally referred to by reference numeral 100. The lens actuator 100 includes a housing 102. The housing 102 can have an inner cavity 102a for storage of internal components or merely be a plate for fastening of such components thereon. A driven member 104 in the form of a lens holder is movably disposed on the housing 102. The lens holder 104 holds a lens 106 and is movable with respect to the housing 102 about a direction indicated by arrow A in either or both of the +A or −A directions. Bearings 108 are used to provide the relative movement between the housing 102 and lens holder 104. Any bearings known in the art can be so utilized, such as linear bearings. Such linear bearings can utilize ball bearings or merely have contacting surfaces in a sliding relationship. The housing 102 and lens holder 104 are attached to the bearings 108 by any means known in the art, such as by rivets, screws, press fit or adhesives. The lens holder 104 can also have an inner cavity 104a for shielding an optical axis B associated with the lens 106. However, the lens holder 104 need only hold and retain the lens thereon and thus may take on any shape. An imaging means 110 may be provided in communication with the optical axis B of the lens 106 for imaging images from the lens 106. Although shown on an exterior of the lens holder 104, the imaging means 110 may also be disposed in the inner cavity 104a. Such imaging means 110 may be any device known in the art for capturing images such as a CCD camera for capturing image data or an analog camera for capturing optical images. The imaging means 110 is generally fixed relative to the lens holder 104. However, the imaging means 110 can also move as long as there is a relative movement between itself and the lens holder 102. The lens 106 is shown schematically as a single lens 106 but may be a series of lens for accomplishing a desired optical effect, such as an objective lens system. Thus, those skilled in the art will appreciate that a relative movement between the lens holder 104 (and lens 106 attached thereto) and the imaging means 110 can provide for a fine focus and/or zoom adjustment. Also provided is a mounting plate 112 fastened to the housing 102. The mounting plate 112 is generally fixed to a substrate or other structure, as is the imaging means 110. Thus, a relative movement between the housing 102 and the lens holder 104 typically also results in a relative movement between the lens 106 and the imaging means 110.

The lens actuator 100 includes a preloading means for providing a normal force (Fn) between the housing 102 and lens holder 104 such that a friction force between the housing and driven member resulting from the normal force (Fn) must be overcome to initiate a relative movement between the housing 102 and lens holder 104. Such preloading means provides the normal force (Fn) on the bearings 108 to retain the lens actuator 104 relative to the housing 102. For all intents and purposes, the normal force (Fn) “fixes” the lens holder 104 relative to the housing 102. Stated another way, the friction level in the bearings 108 (which is a function of the normal force Fn and a coefficient of friction) is such that with regular disturbance levels (e.g., 2-3 g), the lens holder 104 will not move. Thus, the preloading means together with the friction coefficient of the bearings 108 generates a friction in the order of a number of gs. Therefore, when no forces are applied to the lens actuator 100, the lens holder 104 is “fixed” and therefore, stabilized at a certain position relative to the housing 102. The friction force is generally in the A direction (perpendicular to the direction of the normal force). Therefore, a driving force for moving the lens holder 104 must have at least a component in the A direction. Where such component exceeds the friction force, a relative movement of the lens holder 104 results. Typically, regular disturbance levels in a mobile camera are smaller than 1 g, so a friction level of 2-3 g will keep the lens holder 104 fixed at a certain position. If the friction level is overcome with a driving force, a relative movement is initiated between the housing 102 and lens holder 104. The lens actuator 100 also includes a driving means for generating such driving forces to overcome the friction force and drive the lens holder 104 relative to the housing 102 (and imaging means 110).

The preloading means can comprise one or more magnets associated with the lens holder 104 and a ferric member for providing a magnetic attraction force between the lens holder 104 and the ferric member, where the magnetic attraction force is substantially equal to the normal force (Fn). The magnet 114 can be fixed to an outer surface of the lens holder 104, such as in a window 116 formed on an outer surface of the lens holder 104. The magnet 114 can be fixed into the window 116 by any means known in the art, such as by an adhesive. The magnet 114 can be disposed in the window 116 such that a portion thereof protrudes from the lens holder 104 and is disposed in the cavity 102a of the housing 102. The ferric member can be a separately supplied member that provides an attraction to the magnet 114 or such ferric member can be the mounting plate 112 attached to the housing 102. The ferric member or mounting plate can be entirely composed of a ferric material or contain a ferric material, such as iron. For example, the mounting plate 112 can include a ferric plate that is disposed on the mounting plate, such as by screws, and protrudes into the cavity 102a proximate the magnet 114. Other preloading means are also possible, such as spring elements (not shown) for biasing the housing 102 towards the lens holder 104.

The driving means can comprise a magnetic drive system. The magnetic drive system can comprise a drive coil 118 disposed proximate the magnet 114, such as in the cavity 102a of the housing 102 so that the magnet 114 can generate a field in the drive coil 118. The drive coil 118 can be retained in the housing 102 by any means known in the art, such as by an adhesive. The driving means also can include a control means, such as a control circuit 120 for generating a drive current in the drive coil 118 to generate either a positive drive force (F_{D+}) (in the positive A direction) on the lens holder 104 or a negative drive force (F_{D-}) (in the negative A direction) which overcome the friction force and results in a relative movement of the lens holder 104. The control circuit 120 is operatively connected to a power supply 122 to selectively generate such drive current in the drive coil 118. The control circuit 120 can also be operatively connected to the imaging means 110 to establish a feedback loop for selectively driving the drive coil 118. For example, the control circuit 120 can include software (e.g., sharpness detection) for detecting a proper focus of an image and can drive the drive coil 118 in step increments to achieve such proper focus.

The operation of the lens actuator 100 of FIGS. 1-3 will now be explained with reference to FIGS. 4A and 4B. FIG. 4A illustrates a graph showing current pulses applied to the drive coil 118 versus time. The current pulses are applied to the drive coil 118 (under the control of the control circuit 120) in order to step the lens holder 104 relative to the housing 102 (and imaging means 110) for a predetermined increment, such as between 5 and 50 μm steps. First an acceleration pulse 124 is applied to the drive coil 118 such that a corresponding force level (either F_{D+} or F_{D-} depending on the desired direction of the step) exceeds the friction level in the system (which is a function of the normal force Fn). The lens holder 104 starts moving from the acceleration pulse. After the acceleration pulse 124 is applied, a deceleration pulse 126 is applied to stop the movement of the lens holder 104. After the deceleration pulse 126 stops, the friction forces (shown as a range between the dashed lines 127) dominate again and the lens holder 104 stops at a different position (in the + or − A direction). The same pattern of acceleration and deceleration pulses 124, 126 can be repeated after a repetition time (t_{R}) to produce any number of steps in either or both of the + or − A directions. The duration of the pulses to achieve a step on the order of about 5 to 50 μm can be on the order of a fraction of a msec to several msecs. Although, the operation of the lens actuator 100 utilizes both acceleration and deceleration pulses 124, 126, only the positive acceleration pulses 124 can be used, but with less accuracy. Referring now to FIG. 4B, there is shown a graphical representation of the acceleration and deceleration pulses 124, 126 and the resulting steps 128 resulting therefrom. The plateaus 130 represent the “fixation” of the lens holder 104 during the repetition time (t_{R}). Although FIG. 4B shows the steps 128 occurring in the same direction, they can also occur in an opposite direction or in back and forth directions.

Those skilled in the art will appreciate that the lens actuator described above is relatively inexpensive and simple and has no power dissipation in case no movement of the lens is necessary. Furthermore, those skilled in the art will appreciate that the lens actuator described above is rather robust since it has no fragile hinges or other moving parts and can survive high g shock levels, such as a 2000 g-shock level.

Although described with regard to a typical mobile camera, other types of devices in which a stepping on the order of several μM is needed and/or where a sensor system is too expensive can utilize an actuator as discussed above. The amount of the friction level can also be increased by increasing the normal force and/or the friction level in the bearings to provide a stable system under much higher regular disturbance levels than what is disclosed above.

Although described with respect to a single coil and magnet, the actuators described above can utilize two or more coils and/or magnets. For example, two or more coils can be provided on the housing and two or more magnets can be provided on the driven member. Furthermore, one, two or more coils can be provided on the driven member and one, two or more magnets can be provided on the housing. Still further, the two or more magnets can be replaced by a single multipole magnet. Where the one or more magnets are provided on the housing, the ferric member can be provided on the driven member. Lastly, the ferric member for preloading the magnet can also be a magnet, as long as it provides the required normal force. In this case, there would be magnets associated with both the housing and driven member. Thus, the term “ferric member” as used herein also contemplates a magnet.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. An actuator (100) comprising:
a housing (102);
a driven member (104) movably disposed with respect to the housing;
a preloading means (112, 114) for providing a normal force (Fn) between the housing and driven member such that a friction force between the housing and driven member resulting from the normal force must be overcome to initiate a relative movement between the housing and driven member; and
a driving means (118, 120) for overcoming the friction force and driving the driven member relative to the housing.

2. The actuator of claim 1, further comprising a bearing (108) disposed between the housing and driven member, wherein the preloading means provides the normal force on the bearing.

3. The actuator of claim 1, wherein the driven member is a lens holder for holding a lens (106).

4. The actuator of claim 3, further comprising an image sensor (110) for acquiring image data through the lens, wherein the relative movement of the lens holder provides one of a focus and zoom adjustment for the image sensor.

5. The actuator of claim 1, wherein the preloading means comprises a magnet (114) associated with the driven member and a ferric member (112) for providing a magnetic attraction force between the driven member and the ferric member, wherein the magnetic attraction force is substantially equal to the normal force.

6. The actuator of claim 5, wherein the preloading means comprises two or more magnets.

7. The actuator of claim 5, wherein the magnet is a multipole magnet.

8. The actuator of claim 5, wherein the ferric member is a mounting plate (112) attached to the housing, the mounting plate containing a ferric material.

9. The actuator of claim 4, wherein the driving means comprises a magnetic drive system (118, 120).

10. The actuator of claim 9, wherein the magnetic drive system comprises:
a drive coil (118), the magnet generating a field in the drive coil; and
control means (120) for generating a drive current in the drive coil to generate a drive force (F_{D+}, F_{D-}) on the driven member which overcomes the friction force and results in a relative movement of the driven member.

11. The actuator of claim 10, wherein the drive coil is disposed in the housing.

12. The actuator of claim 10, comprising two or more drive coils.

13. A method for driving an actuator (100), the method comprising:
providing a normal force (Fn) between a housing (102) and a driven member (104) such that a friction force between the housing and driven member resulting from the normal force must be overcome to initiate a relative movement between the housing and driven member; and
overcoming the friction force to drive the driven member relative to the housing.

14. The method of claim 13, wherein the providing comprises providing a magnet (114) associated with the driven member and a ferric member (112) for providing a magnetic attraction force between the driven member and the ferric member, wherein the magnetic attraction force is substantially equal to the normal force.

15. The method of claim 14, wherein the overcoming comprises:
generating a field in a drive coil (118) with the magnet; and
generating a drive current in the coil to generate a drive force (F_{D+}, F_{D-}) on the driven member which overcomes the friction force and results in a relative movement of the driven member.

16. The method of claim 13, wherein the driven member is associated with a lens (106) and the method further comprises providing one of a focus and zoom adjustment between the lens and a camera (110) due to the relative movement between the driven member and housing.

17. A lens actuator (100) for a camera system, the lens actuator comprising:
a housing (102);
a lens holder (104) for holding a lens (106), the lens holder being movably disposed with respect to the housing;
a camera (110) in optical communication with the lens;
a preloading means (112, 114) for providing a normal force (Fn) between the housing and lens holder such that a friction force between the housing and lens holder resulting from the normal force must be overcome to initiate a relative movement between the housing and lens holder; and
a driving means (118, 120) for overcoming the friction force and driving the lens holder relative to the housing.

18. The lens actuator of claim 17, further comprising a bearing (108) disposed between the housing and lens holder, wherein the preloading means provides the normal force on the bearing.

19. The lens actuator of claim 17, wherein the preloading means comprises a magnet (114) associated with the lens holder and a ferric member (112) for providing a magnetic attraction force between the lens holder and the ferric member, wherein the magnetic attraction force is substantially equal to the normal force.

20. The lens actuator of claim 19, comprising two or more magnets.

21. The lens actuator of claim 19, wherein the magnet is a multipole magnet.

22. The lens actuator of claim 16, wherein the ferric member is a mounting plate (112) attached to the housing, the mounting plate containing a ferric material.

23. The lens actuator of claim 15, wherein the driving means comprises a magnetic drive system (118, 120).

24. The lens actuator of claim 23, wherein the magnetic drive system comprises:
a drive coil (118), the magnet generating a field in the drive coil; and
control means (120) for generating a drive current in the drive coil to generate a drive force (F_{D+}, F_{D-}) on the driven member which overcomes the friction force and results in a relative movement of the lens holder.

25. The lens actuator of claim 24, wherein the drive coil is disposed in the housing.

26. The lens actuator of claim 24, comprising two or more drive coils.
